(19) United States
(12) Patent Application Publication
(10) Pub. No.: US 2011/0153807 A1
(43) Pub. Date: Jun. 23, 2011

(54) Systems and Methods for Preemptive DNS Resolution

(76) Inventors: Lorenzo Vicisano, Berekeley, CA (US); Mark Watson, San Francisco, CA (US)

(21) Appl. No.: 12/643,809

(22) Filed: Dec. 21, 2009

(51) Int. Cl. G06F 15/16

(52) U.S. Cl. 709/224; 709/245; 709/227

(57) ABSTRACT

Disclosed are systems, methods and computer program products for preemptive DNS resolution. A DNS proxy is provided for inspecting data packets transmitted to a client device on a first communication link. The proxy identifies one or more host device names embedded in the inspected data packets and resolves IP addresses associated with the embedded host device names. The proxy device transmits the inspected data packets to the client device without alterations on a second communication link. The second communication link has significantly higher propagation latency than the first communication link. The proxy then transmits to the client device, independent of the inspected data packets, the one or more host device names and the associated resolved IP addresses for use by the client device to establish connections to the host devices identified in the inspected data packet.

### BACKGROUND

1. Field

This disclosure relates generally to the field of communication networks and more specifically to the systems and methods for application acceleration through preemptive DNS resolution.

2. Background

Wireless communication systems, also known as radio access networks (RANs), provide mobile device users with wireless access to high-speed, large bandwidth core IP networks. These wireless communication systems may be multiple-access systems capable of supporting communication with multiple mobile devices by sharing the available system resources (e.g., bandwidth and transmit power). Examples of such multiple-access systems include code division multiple access (CDMA) systems, time division multiple access (TDMA) systems, frequency division multiple access (FDMA) systems, orthogonal frequency division multiple access (OFDMA) systems, Universal Mobile Telecommunications Systems (UMTS) including WCDMA, HSPA and HSUPA, 3GPP Long Term Evolution (LTE) systems, and other types of wireless communication systems.

Generally, communications on IP networks require communication devices to resolve host and domain names of computers, servers or other network devices into the associated IP addresses before connection to these devices can be established. Domain Name System (DNS) servers perform host name resolution services. For devices physically connected to the core IP network, host name resolution is a relatively fast and seamless process generally performed by the DNS servers hosted by the Internet Service Provider (ISP). However, for mobile devices connected to the IP network through a radio access network, host name resolution adds significant communication delay, because of small bandwidth, high radio link propagation latency, data retransmissions due to high packet error rates and other factors attributed to the wireless communication environment. Therefore, there is a need to improve DNS resolution procedures in wireless communication systems.

### SUMMARY

The following presents a simplified summary of one or more aspects of mechanisms for application acceleration through preemptive DNS resolution in a wireless communication environment. This summary is not an extensive overview of all contemplated aspects, and is intended to neither identify key nor critical elements of the invention nor delineate the scope of any or all aspects thereof. Its sole purpose is to present some concepts of one or more aspects in a simplified form as a prelude to the more detailed description that is presented later.

Disclosed herein are various aspects of systems, methods and computer program products for preemptive DNS resolution. The system may include a DNS proxy device provided between a radio access network (RAN) and a core IP network for providing preemptive domain name resolution for communications to and from mobile devices connected to the RAN. In one aspect, the DNS proxy may be hosted by an IP access gateway, such as PDSN gateway. Because of its direct, physical connection to the core IP network, the DNS proxy device has a much faster access time to the DNS servers of the IP network than the mobile devices. This enables the DNS proxy to assist mobile devices in providing translation of host and domain names in communications to the mobile devices, thereby accelerating operation of various applications running on the mobile devices.

In one aspect, the DNS proxy inspects data packets transmitted to mobile device on a first communication link. The proxy identifies one or more host device names embedded in the inspected data packets and resolves IP addresses associated with the one or more embedded host device names. The proxy device transmits the inspected data packets to the mobile device without alterations on a second communication link. The second communication link may have higher propagation latency than the first communication link. The proxy then transmits to the mobile device, independent of the inspected data packets, the one or more host device names and the associated resolved IP addresses for use by the client device to establish connections to the host devices identified in the inspected data packet. In this manner, when a mobile device needs to access a host device identified in the inspected data packets, the IP address of the host device is already available and the mobile device does not need to repeat IP address resolution process over the second communication link

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects of the invention will hereinafter be described in conjunction with the appended drawings, provided to illustrate and not to limit the disclosed aspects, wherein like designations denote like elements, and in which:

FIG. 1 is an illustration of a wireless communication system utilizing aspects of preemptive DNS resolution mechanisms disclosed herein.

FIG. 2 is an illustration of an example methodology for preemptive DNS resolution.

FIG. 3 is an illustration of another example methodology for preemptive DNS resolution.

FIG. 4 is an illustration of an example DNS proxy implementing aspects of preemptive DNS resolution mechanisms disclosed herein.

FIG. 5 is an illustration of an example system implementing aspects of preemptive DNS resolution mechanisms disclosed herein.

FIG. 6 is an illustration of an example wireless communication system utilizing aspects of preemptive DNS resolution mechanisms disclosed herein.

### DETAILED DESCRIPTION

Various aspects of methodologies for preemptive DNS resolution in a wireless communication environment are now described with reference to the drawings. It should be noted however that the methodologies for preemptive DNS resolution are not limited to the wireless communication environment, but may be used in any communication network characterized by long propagation delays between client devices and a wide area IP network and in which preemptive DNS resolution may accelerate operation of applications running on the client devices. It should be further noted that the terms “host name” and “domain name” are used interchangeably herein despite subtle technical differences between these terms. In the following description, for purposes of explanation, numerous specific details are set forth in order to provide a thorough understanding of one or more aspects. It may be evident, however, that such aspect(s) may be practiced without these specific details.

As used in this disclosure, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet or other types of packet-switched networks with other systems by way of the signal.

Moreover, various aspects or features of methodologies for preemptive DNS resolution described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

Various aspects or features of methodologies for preemptive DNS resolution in a wireless communication environment will be presented in terms of systems that may include a number of mobile devices, components, modules, and the like. It is to be understood and appreciated that the various systems may include additional devices, components, modules, etc. and/or may not include all of the devices, components, modules etc. discussed in connection with the figures. A combination of these approaches may also be used.

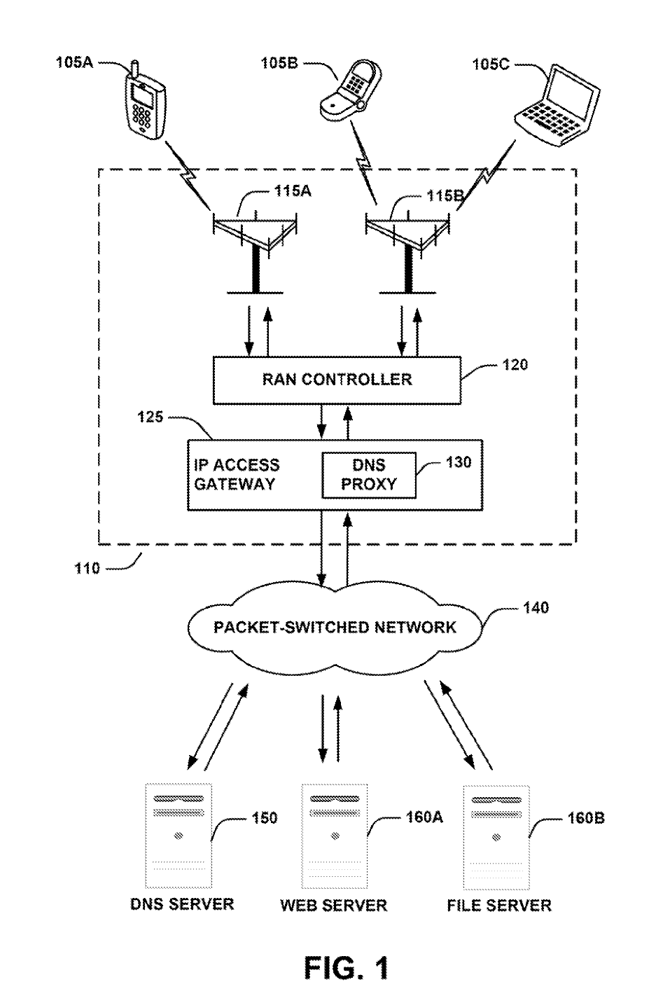

FIG. 1 illustrates one aspect of a wireless communication system that includes one or more mobile devices 105, one or more radio access networks (RAN) 110, a core IP network 140, such as the Internet, one or more DNS servers 150, and various content and application servers 160, such as Web servers, file servers, mail servers, multimedia servers and other. In one aspect, mobile device 105 can be a cellular telephone, a cordless telephone, a Session Initiation Protocol (SIP) phone, a personal digital assistant (PDA), a handheld device having wireless connection capability, a laptop computer, or other processing device connected to a wireless modem. Mobile device 105 may be a multi-mode communication device operable to access several different radio access networks 110. Mobile device 105 may support data, voice and video services, including broadband Internet services, such as Web browsing, voice over IP (VoIP), IP-TV, multimedia streaming, file downloading and other types of services. Device 105 may also be called a subscriber unit, subscriber station, mobile station, mobile, remote station, remote terminal, access terminal, user terminal, terminal, wireless communication device, user agent, user device, or user equipment (UE).

In one aspect, the radio access network 110 may include, but are not limited to, CDMA, TDMA, FDMA, OFDMA, SC-FDMA, TD-SCDMA and other wireless communication systems. The terms “system” and “network” are used interchangeably herein. A CDMA system may implement a radio technology such as Universal Terrestrial Radio Access Network (UTRAN), cdma2000, etc. UTRAN includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRAN (E-UTRAN), Ultra Mobile Broadband (UMB), IEEE 802.11 (Wi-Fi), IEEE 802.16 (WiMAX), IEEE 802.20, Flash-OFDM, etc. UTRAN and E-UTRAN are part of Universal Mobile Telecommunication System (UMTS). 3GPP Long Term Evolution (LTE) is a release of UMTS that uses E-UTRAN, which employs OFDMA on the downlink and SC-FDMA on the uplink. UTRAN, E-UTRAN, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Generally, RAN 110 provides mobile devices 105 with radio access to the packet-switched core network 140, such as the Internet. In one aspect, RAN 110 may include one or more radio base stations 150 having multiple antenna groups and/or a transmitter/receiver chain that can in turn comprise a plurality of components associated with radio signal transmission and reception (e.g., processors, modulators, multiplexers, antennas, etc. (not shown)) to and from mobile devices 105. RAN 110 further includes a RAN controller 120 which provides data connectivity between mobile devices 105 and an IP access gateway 125. The main functions of the controller 120 include establishment, maintenance and termination of radio link flows, radio resource management and mobility management. The radio link flows may include, but are not limited to Radio Link Protocol (RLP) flows and Radio Link Control (RLC) flows. Each radio link flow may include multiple IP data flows generated by the applications running on the mobile device 105. For each radio link flow, controller 120 creates A10/A11 bearer connections to carry data packets from device 105 to gateway 125.

IP access gateway 125, also known as medium access gateway (MAG), is a server or router that connects RAN 110 and IP network 140. In one aspect, gateway 125 may be implemented as a Packet Data Serving Node (PDSN). Generally, gateway 1125 is responsible for tracking the mobile devices' movements to and from RAN 110, aggregating data traffic from RAN controllers 120 and providing access to the servers 160. If RAN 110 supports Proxy Mobile IPv6 (PMIP) protocol, gateway 125 may also function as a proxy agent for mobile IPv4 and IPv6 packet transport, signaling and data transmission/reception to/from mobile devices 105 and services 160. For transporting data between mobile device 105 and services 160, gateway 140 creates bidirectional IP tunnels and associates multiple radio links flow carried by the A10/A11 bearer connections from controller 120 to the created IP tunnels. When gateway 125 receives data packet from mobile device 105, it identifies server 160 to which the packet is addressed and the associated IP tunnel; it then encapsulates the received packets in a new IP packet and transmits it through the appropriate IP tunnel to the server 160. When data packet is received through the IP tunnel from the server 160, IP access gateway 125 de-encapsulates it, identifies the mobile device 105 to which the packet is addressed and the appropriate radio link flow, and forwards the data to mobile device 105.

As indicated above, communications on the IP network 140 require mobile device 105 to resolve host and domain names of computers, servers or other network devices 160 into the associated IP addresses before connections to these devices can be established. To that end, a Web browser or other applications running on the mobile device 105 may include a DNS resolver component (not depicted), which upon request from the application to connect to a host device attempts to resolve an IP address of the host device using the host device name. For example, a host name of the Web server 160A may be webserver.qualcomm.com and the corresponding IP address may be 208.77.188.166. To resolve the IP address of the Web server 160A, the DNS resolver first searches its own cache to determine if the requested IP address has already been translated and stored in the cache. If the requested IP address is not in the cache, the DNS resolver queries a local DNS server (not depicted) hosted by the RAN 110 or various remote DNS servers 150, until one of these DNS servers provides to the DNS resolver the IP address information of the host device.

Once the IP address of the Web server 160A has been resolved, the mobile device 105 may establish an IP flow through the RAN 110 and IP network 140 to the Web server 160A. In response, Web server 160 may send to the mobile device 105 an HTML document, which may contain therein a plurality of embedded domain or host names or links to other resources on the IP network 140. For example, the HTML document may contain a host name of the file server 160B, which stores various images embedded in the HTML document. For each embedded host or domain name, the mobile device 105 has to repeat DNS resolution process in order to retrieve resources identified by the embedded host or domain names. For devices physically connected to the IP network 140, DNS resolution process is a relatively fast because of the short propagation delays on a high-speed, large-bandwidth core IP network 140 to which those devices are connected. For example, network 140 may be a gigabit Ethernet, optical wide area network (WAN), or other high-speed network. However, for mobile devices 105 connected to the network 140 through the RAN 110, DNS resolution process adds significant communication delay because of high radio link propagation latency, data retransmissions due to high packet error rates and other factors attributed to the RANs.

To accelerate DNS resolution process for mobile devices 105 connected to the RAN 110, a DNS proxy 130 that performs preemptive DNS resolution may be provided at the boundary of the RAN 110 and core IP network 140. In one aspect, the DNS proxy 130 may be implemented as a software component of the IP access gateway 125. In another aspect, proxy 130 may be implemented as a software component of the local DNS server of the RAN 110. Yet in another aspect, proxy 130 may be implemented as a standalone device connected to the RAN controller 120 or IP access gateway 125. It should be noted that the DNS proxy may also be used in wireless local area networks (WLAN), such as networks described in IEEE 802.11 standards, to provide preemptive DNS resolution to wireless devices connected to a WLAN. In this aspect, the DNS proxy may be implemented as a software component of a wireless access point (AP) that connects the WLAN to the wired IP network. The DNS proxy may also be used in wired LANs, such as Ethernet networks. In this aspect, the DNS proxy may be implemented as a software component of the network router, bridge, concentrator or other routing device connecting a LAN with a WAN.

To provide effective preemptive DNS resolution services, the DNS proxy 130 may operate as a Web proxy that inspects HTTP traffic transmitted from the IP network 140 to one or more mobile devices 105 for presence of embedded domain and host names. In other words, whilst logically the DNS proxy performs Application layer (OSI model) processing, the actual processing may be done on a packet-by-packet basis at the IP layer (i.e. such that the Transport, TCP, operates end-to-end). For example, HTTP allows message bodies to be compressed, so the domain names are not directly visible in the compressed data stream. Unlike traditional DNS proxies that uncompress the data payload of the intercepted packets, find and re-write the domain names and recompress the data payload. The DNS proxy 130 may identify compressed data and passes without delay or alterations the data packets to the mobile device 105—keeping the TCP transport end-to-end—but in parallel the data packets may be decompressed to identify the embedded host and domain names therein. In this manner, the data stream being forwarded unaltered at the IP layer and preemptive DNS resolution is performed on a copy of the stream, which is processed at the Application layer.

As indicated above, during packet inspection process, the DNS proxy 130 identifies embedded host and domain names. In one aspect, the DNS proxy 103 may use string pattern matching technique to identify embedded host and domain names. Generally, host and domain names are strings composed of sequences of ASCII characters in the ranges [a-z], [0-9] and “-” separated by “.”. In addition, domain names often end with “.com”, “.org”, “.edu” or other domain identifiers, and may contain “http”, “ftp”, “xml” or other protocol identifiers. In protocol messages (even in binary protocols) these are very often transported without any special encoding: as ASCII strings aligned to the byte boundary. Under these assumptions, the DNS proxy 130 can detect embedded host and domain names by parsing the binary payload of IP packets octet-by-octet, interpreting each octet as an ASCII character and looking for strings of ASCII characters that match the host or domain name character pattern. In case the nature of the traffic is unknown, either because the DNS proxy does not understand the application-level protocol (e.g. HTTP) or because it is not programmed to do so, the DNS proxy can still inspect the traffic at the IP layer (network layer in OSI model), packet by packet, and make educated guesses on host name detection, using string pattern matching technique described above. Similar processing can be performed at the TCP layer (for TCP traffic). In this case, the DNS proxy 130 would intercept IP packets and associate them with a given TCP stream; re-assemble the stream; and perform the pattern matching. This approach allows identification of host and domain names across packet boundaries. It should be noted that in the context of the radio access network 110, the DNS proxy 130 may intercept IP packets transmitted on multiple forward radio link flows of the RAN 110, i.e., packets transmitted from the IP network 140 to mobile devices 105, and inspect these packets for presence of embedded host and domain names.

Having identified one or more embedded host or domain names in the inspected data packet, the DNS proxy 130 may attempt to translate an embedded host or domain name into its associated IP address. For example, the DNS proxy 130 may first check its local cache to determine if the IP address of the embedded host name has been previously resolved and thus stored in proxy's cache. If the IP address is not in the cache, the proxy 130 may query a local DNS server of the RAN 110 or various remote DNS server 150 using conventional DNS resolution techniques. Once an IP address of the embedded host name is resolved, the proxy 130 may store the translated IP address in its cache and transmit it to the mobile device 105 to which the data packet with the embedded host name was addressed. The proxy 130 may then transmit the translated IP address information for one or more domain or host names to the DNS resolver component of the mobile device 105 using standard DNS protocol messages or using custom UDP or XML messages, or the like.

When the mobile device 105 receives a message from the DNS proxy 130, it retrieves the host name/IP address information contained in the message and stores it in a cache of its DNS resolver component or any other memory location. When the application on the mobile device 105 to which a data packet with the embedded host names was addressed attempts to establish connections to the network devices identified by the embedded host names, it activates the DNS resolver component, which can quickly retrieve the corresponding IP addresses from its cache and provide them to the application. In this manner, the DNS resolver of the mobile device 105 does not have to query through the radio access network 110 any local and remote DNS servers 150, which can be a relatively time consuming process due to the long radio link propagation delays and possibly numerous data retransmissions due to errors on the radio access network 110. Having resolved the IP addresses of the network devices identified by the embedded host names in the received data packet, the mobile device 105 can establish connections to these network devices using their IP addresses and retrieve the necessary information. Through preemptive DNS resolution provided by the DNS proxy 130, the performance of the applications running on the mobile device 105 can be significantly accelerated and user experience improved accordingly.

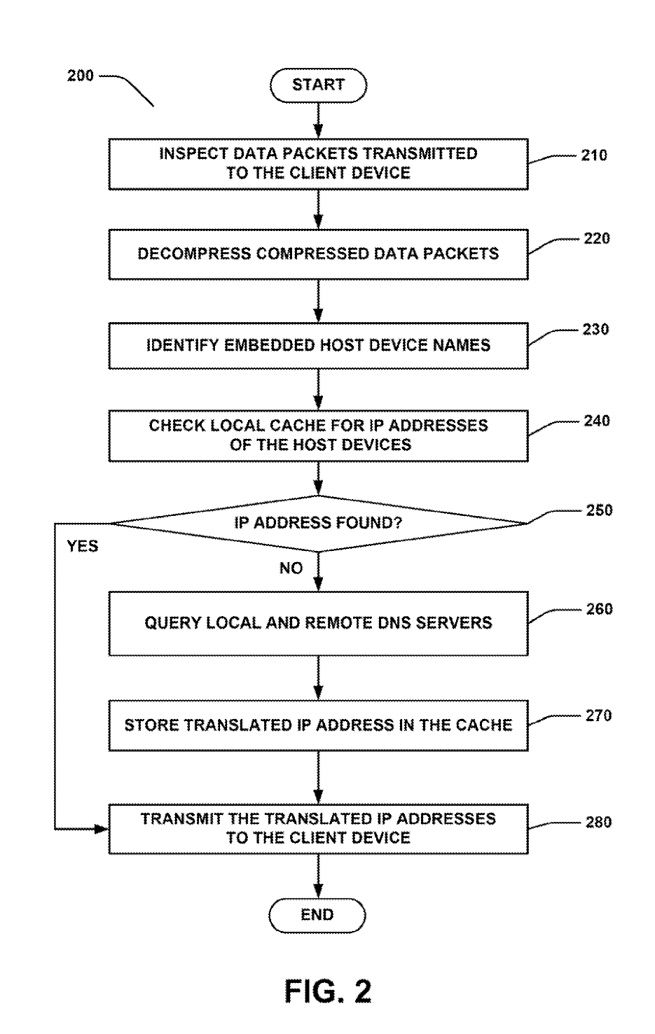

FIG. 2 illustrates one example methodology for preemptive DNS resolution by a DNS proxy. At step 210, a DNS proxy, such as proxy 130, inspects data packets transmitted from a WAN, such as IP network 140, to one or more client devices on a LAN, WLAN or RAN, such as mobile devices 105. If the data in the inspected packets is compressed, at step 220, the DNS proxy may decompress the compressed data. At step 230, the DNS proxy identifies host (and domain) names embedded in the inspected data packets, such as “.com” or “.org” domain names. At step 240 the DNS proxy may first check its local cache to determine if the IP address of the embedded host name has been previously translated and is stored in the proxy's cache. If at step 250 the IP address is found in the cache, the DNS proxy transmits it to the client device at step 280. If the IP address is not in the cache, at step 260, the DNS proxy queries a local DNS server or various remote DNS servers using conventional DNS resolution techniques. Once an IP address of the embedded host name is resolved, at step 270, the DNS proxy stores the translated IP address in its cache. At step 280, the DNS proxy transmits the host name and IP address information to the client device using standard DNS protocol messages or custom UDP or XML messages or using other known communication technologies. It should be noted that steps 240, 250 and 270 are optional and depend on whether the DNS proxy has a local cache for storing resolved IP addresses.

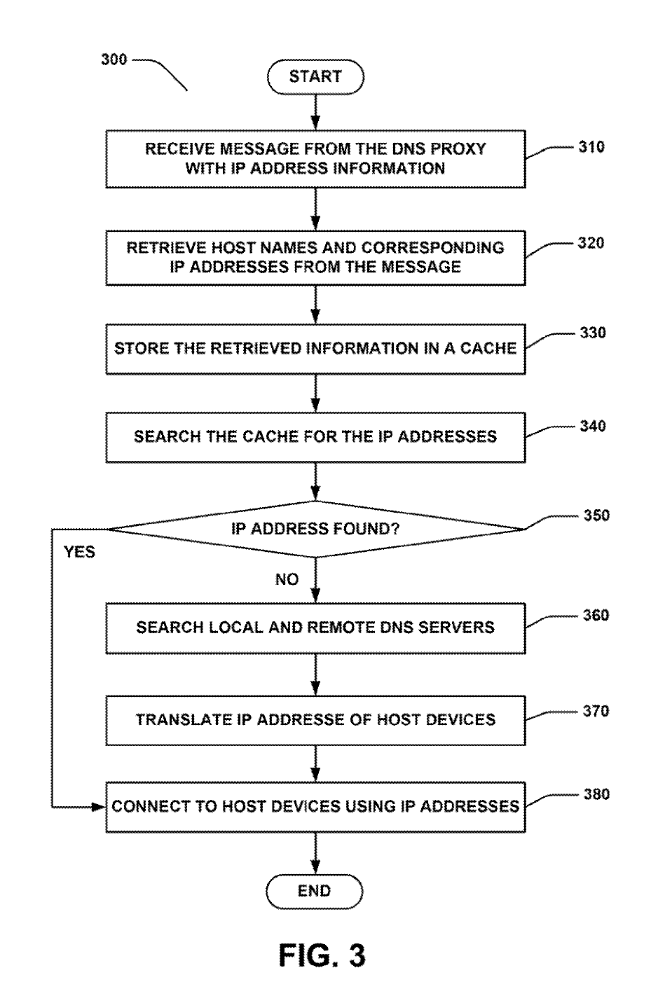

FIG. 3 illustrates one example methodology for preemptive DNS resolution that may be implemented at a client device. At step 310, a client device, such as DNS resolver component of the mobile device 105, receives a message from the DNS proxy. The message may be a standard DNS protocol message or a custom UDP or XML message. At step 320, the client device retrieves from the message the host names and associated IP address information. At step 330, the client device stores it in a cache of its DNS resolver component or any other memory location. When an application, such as a Web browser, on the client device attempts to establish connections to the network devices identified by the embedded host names, at step 340, the client device activates the DNS resolver component, which at step 340 searches its cache for the IP addresses associated with embedded host names. If IP addresses have been preemptively resolved with the assistance of the DNS proxy, the IP addresses will be found at step 350 in the cache of the DNS resolver, the application may then quickly establish connections to the host device at step 380. If the IP addresses are not in the cache, at step 360, the DNS resolver queries local and remote DNS server using conventional DNS resolution techniques. When the IP addresses of the host devices are resolved at step 370, the application may establish connection to the host devices at step 380.

The above-disclosed methodologies for preemptive DNS resolution accelerate performance of mobile applications and provide other advantages. For example, unlike other methods for preemptive DNS resolution, the present implementations do not delay data traffic to the client device in order to translate embedded host device names and replace them in the data packets with the resolved IP addresses. The preemptive DNS resolution is done asynchronously to the forwarding of the data packets to the client device. This allows for a great deal of flexibility in the implementations. In addition, the disclosed methodologies do not undermine techniques implemented at the client device for verifying the authenticity of the data. Moreover, the disclosed implementations do not introduce risk of breaking the application functionality by breaking the integrity of the data. Lastly, the applicability of these techniques is broadened to applications where the format of the data is unknown to the DNS proxy: the proxy can make an “educated guess” regarding what constitutes a host or domain name. A false positive does not have any seriously adverse affect on the application.

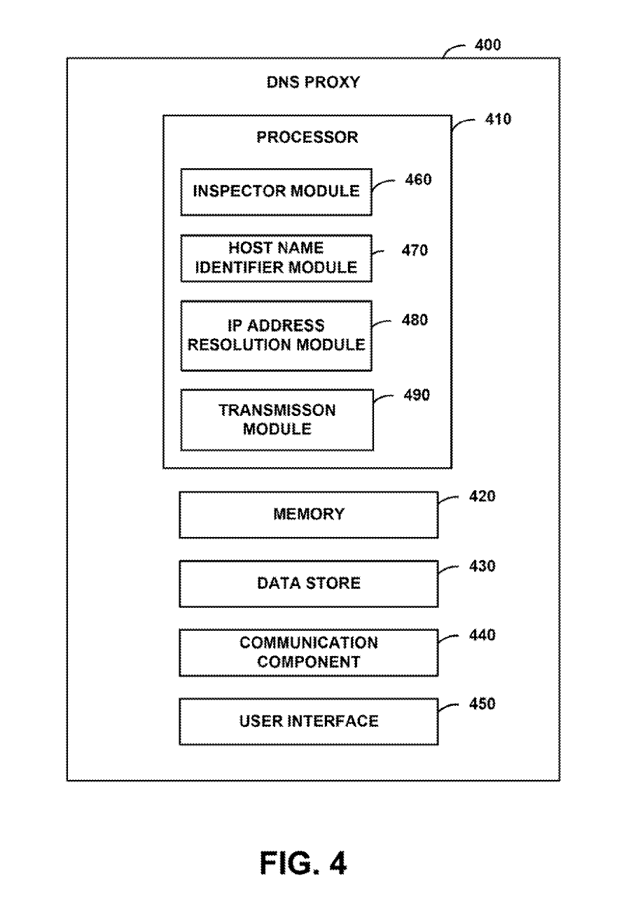

FIG. 4 illustrates an example DNS proxy device 400 operable to perform preemptive DNS resolution for client devices connected to the local area networks or radio access networks in accordance with methodologies disclosed herein. DNS proxy 400 includes a processor 410 for carrying out processing functions associated with preemptive DNS resolution in accordance with the methodologies disclosed herein as well as other functions. Processor 410 can include a single or multiple set of processors or multi-core processors. In one example aspect, processor 410 may include a packet inspection module 460 that implements procedures for inspecting data packets addressed to the client devices. Processor 410 may also include a host name identifying module 470 for identifying host names and domain names in the inspected data packets. Processor 410 may also include an IP address resolution module 480 that performs translation of embedded host and domain names into associated IP addresses. Processor 410 also includes a transmission module 490 that transmits the resolved host device names and the associated IP addresses to the client devices.

DNS proxy 400 further includes a memory 420 coupled to processor 410, such as for storing program instructions for preemptive DNS resolution being executed by processor 410 as well as a proxy cache containing preemptively resolved host and domain names and associated IP addresses. Memory 420 can include any type of memory usable by a computer, such as random access memory (RAM), read only memory (ROM), magnetic discs, optical discs, volatile memory, non-volatile memory, and any combination thereof. Additionally, DNS proxy 400 may further include a data store 430 coupled to processor 410, which can be any suitable combination of hardware and/or software, that provides for mass storage of information, databases, and programs employed in connection with aspects described herein. For example, data store 430 may be a data repository for programs or subroutines not currently being executed by processor 410 as well as files containing algorithms for the preemptive DNS resolution and various data associated therewith.

Further, DNS proxy 400 includes a communications component 440 coupled to processor 410 for searching, establishing and maintaining communications with client devices and local and remote DNS servers as described herein. For example, communications component 440 may include transmit chain components and receive chain components associated with a transmitter and receiver, respectively, operable for interfacing with wireless communication systems and devices of various radio access technologies and protocols. The data transmission module 490 instructs communications component 440 to transmit/receive data to/from one or more client devices and local and remote DNS servers.

DNS proxy 400 may include a user interface component 450 coupled to processor 410 and being operable to receive inputs from a system administrator and further operable to generate outputs for presentation to the system administrator. Component 450 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, component 450 may include one or more output devices, including but not limited to a display, a speaker, a haptic feedback mechanism, a printer, any other mechanism capable of presenting an output to a user, or any combination thereof.

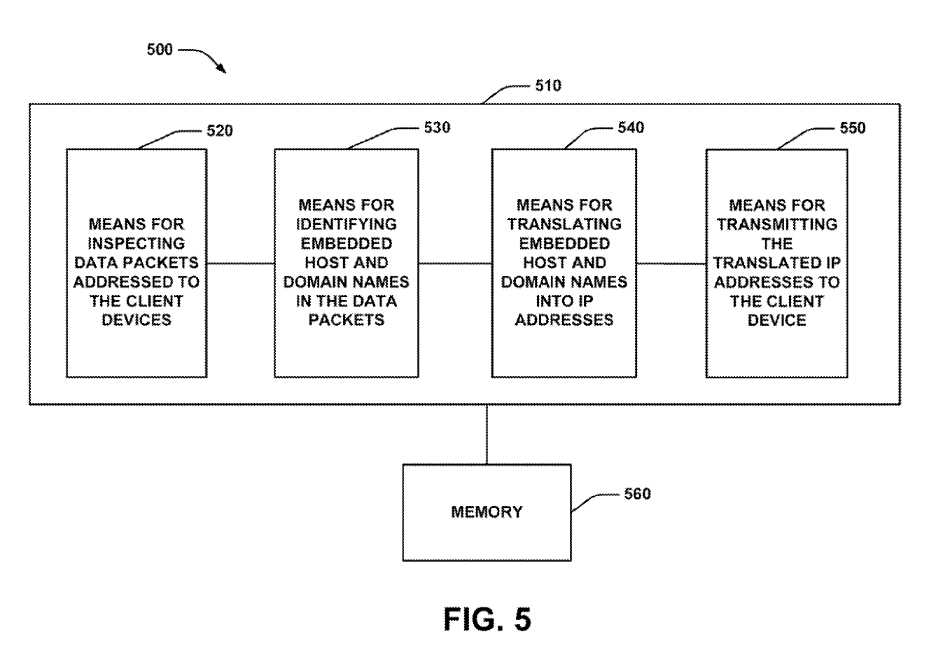

FIG. 5 illustrates a system 500 that may be implemented in a DNS proxy device. As depicted, system 500 includes functional blocks that can represent functions implemented by a processor, software, or combination thereof (e.g., firmware). System 500 includes a logical grouping 510 of electrical components that facilitate execution of algorithms for preemptive DNS resolution as disclosed herein. Logical grouping 510 can include means 520 for inspecting data packets addressed to the client devices. Further, logical grouping 510 includes means 530 for identifying embedded host and domain names in the inspected data packets. In addition, logical grouping 510 includes means 540 for translating embedded host and domain names into the associated IP addresses. Lastly, logical grouping 510 includes means 550 for transmitting the translated IP addresses to the client device. System 500 also includes a memory 560 that retains instructions for executing functions associated with electrical components 520-550. While shown as being external to memory 560, it is to be understood that electrical components 520-550 can exist in memory 560 of the system 500.

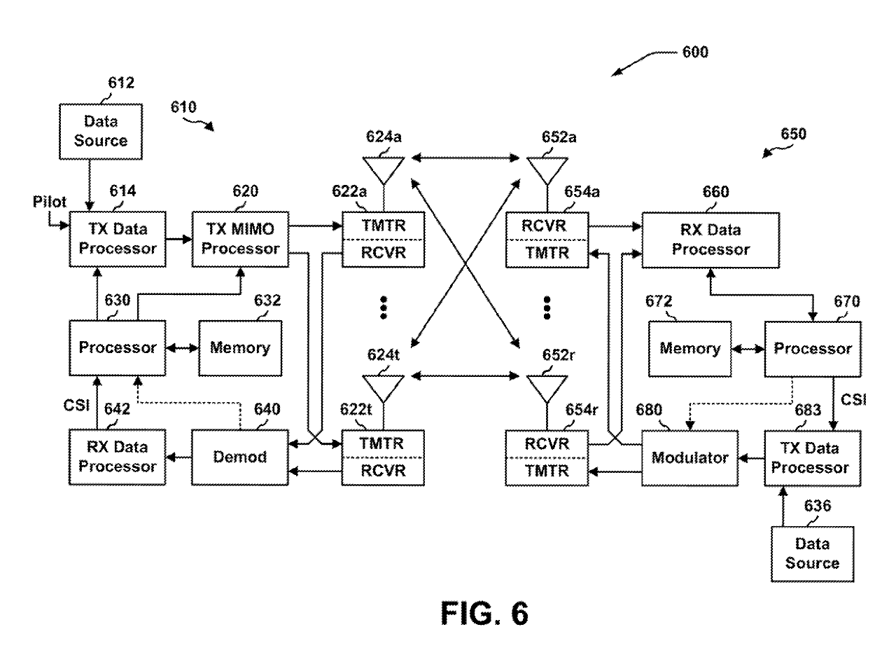

FIG. 6 shows an example of a wireless communication system 600 in which various aspects of the methodologies for preemptive DNS resolution may be implemented. The system 600 depicts one base station/forward link transmitter 610 in a radio access network and one mobile device 650 for sake of brevity. However, it is to be appreciated that system 600 can include more than one base station/forward link transmitter and/or more than one mobile device, wherein additional base stations/transmitters and/or mobile devices can be substantially similar or different from example base station/forward link transmitters 610 and mobile device 650 described below. In addition, it is to be appreciated that base station/forward link transmitter 610 and/or mobile device 650 can employ the systems (FIGS. 1, 4 and 5) and/or methods (FIGS. 2 and 3) described herein to facilitate latency measurement procedures and wireless communication there between.

At base station/forward link transmitter 610, traffic data for a number of data streams is provided from a data source 612 to a transmit (TX) data processor 614. According to an example, each data stream can be transmitted over a respective antenna. TX data processor 614 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 650 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 630.

The modulation symbols for the data streams can be provided to a TX MIMO processor 620, which can further process the modulation symbols (e.g., for OFDM). TX MIMO processor 620 then provides NT modulation symbol streams to NT transmitters (TMTR) 622a through 622t. In various aspects, TX MIMO processor 620 applies beamforming weights to the symbols of the data streams and to the antenna from which the symbol is being transmitted.

Each transmitter 622 receives and processes a respective symbol stream to provide one or more analog signals, and further conditions (e.g., amplifies, filters, and upconverts) the analog signals to provide a modulated signal suitable for transmission over the MIMO channel. Further, NT modulated signals from transmitters 622a through 622t are transmitted from NT antennas 624a through 624t, respectively.

At mobile device 650, the transmitted modulated signals are received by NR antennas 652a through 652r and the received signal from each antenna 652 is provided to a respective receiver (RCVR) 654a through 654r. Each receiver 654 conditions (e.g., filters, amplifies, and downconverts) a respective signal, digitizes the conditioned signal to provide samples, and further processes the samples to provide a corresponding “received” symbol stream.

An RX data processor 660 can receive and process the NR received symbol streams from NR receivers 654 based on a particular receiver processing technique to provide NT “detected” symbol streams. RX data processor 660 can demodulate, deinterleave, and decode each detected symbol stream to recover the traffic data for the data stream. The processing by RX data processor 660 is complementary to that performed by TX MIMO processor 620 and TX data processor 614 at base station/forward link transmitter 610.

A processor 670 can periodically determine which precoding matrix to utilize as discussed above. Further, processor 670 can formulate a reverse link message comprising a matrix index portion and a rank value portion.

The reverse link message can comprise various types of information regarding the communication link and/or the received data stream. The reverse link message can be processed by a TX data processor 638, which also receives traffic data for a number of data streams from a data source 636, modulated by a modulator 680, conditioned by transmitters 654a through 654r, and transmitted back to base station/forward link transmitter 610.

At base station/forward link transmitter 610, the modulated signals from mobile device 650 can be received by antennas 624, conditioned by receivers 622, demodulated by a demodulator 640, and processed by a RX data processor 642 to extract the reverse link message transmitted by mobile device 650. Further, processor 630 can process the extracted message to determine which precoding matrix to use for determining the beamforming weights. It is to be appreciated that in the case of a forward link transmitter 810, as opposed to a base station, these RX components may not be present since data is only broadcasted over the forward link.

Processors 630 and 670 can direct (e.g., control, coordinate, manage, etc.) operation at base station/forward link transmitter 610 and mobile device 650, respectively. Respective processors 630 and 670 can be associated with memory 632 and 672 that store program codes and data. Processors 630 and 670 can also perform computations to derive frequency and impulse response estimates for the uplink and downlink, respectively.

It is to be understood that the aspects described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the aspects are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means known in the art.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects, it should be noted that various changes and modifications could be made herein without departing from the scope of the described aspects as defined by the appended claims. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise.

What is claimed is:

1. A method for communication, comprising:
inspecting, by a proxy device, one or more data packets transmitted to a client device;
identifying one or more host device names embedded in the inspected data packets;
resolving IP addresses associated with the one or more embedded host device names;
transmitting to the client device the inspected data packets without alterations; and
transmitting to the client device, independent of the inspected data packets, the one or more host device names and the associated resolved IP addresses for use by the client device to establish connections to the host devices identified in the inspected data packet.

2. The method of claim 1, wherein identifying one or more host device names embedded in the inspected data packet comprises reconstructing code of the one or more intercepted data packets.

3. The method of claim 1, wherein identifying one or more host device names embedded in the inspected data packet comprises analyzing the inspected data packets using ASCII character string pattern matching.

4. The method of claim 1, wherein resolving the IP addresses further comprises:
searching a local cache of the proxy device for the IP addresses associated with the one or more embedded host device names; and
upon failure to locate the associated IP addresses in the local cache of the proxy device, querying by the proxy device one or more DNS servers to resolve the IP addresses associated with the one or more embedded host device names.

5. The method of claim 1, wherein resolving the IP addresses further comprises storing the one or more identified host device names and the associated resolved IP addresses in a local cache of the proxy device.

6. The method of claim 1, wherein inspecting, by the proxy device, one or more data packets transmitted to the client device comprises inspecting data packets transmitted to the client device on a first communication link having a first propagation latency.

7. The method of claim 6, wherein transmitting to the client device the inspected data packets without alterations comprises transmitting the inspected data packets on a second communication link having a second propagation latency, wherein the first propagation latency is substantially lower than the second propagation latency.

8. The method of claim 7, wherein the client device includes a mobile device, wherein the first communication link includes a core IP network and the second communication link includes a radio access network (RAN), and wherein the proxy device is hosted by an IP access gateway connecting the RAN and the core IP network.

9. The method of claim 7, wherein the first communication link includes a wide area network (WAN) and the second communication link includes a local area network (LAN), and wherein the proxy device is hosted by a router connecting the LAN and WAN.

10. A communication system, comprising:
a processor and a communications component coupled to the processor, the processor being configured to
inspect, by a proxy device, one or more data packets transmitted to a client device;
identify one or more host device names embedded in the inspected data packets;
resolve IP addresses associated with the one or more embedded host device names;
transmit to the client device the inspected data packets without alterations; and
transmit to the client device, independent of the inspected data packets, the one or more host device names and the associated resolved IP addresses for use by the client device to establish connections to the host devices identified in the inspected data packet.

11. The system of claim 10, wherein to identify one or more host device names embedded in the inspected data packet, the processor being further configured to reconstruct code of the one or more intercepted data packets.

12. The system of claim 10, wherein to identify one or more host device names embedded in the inspected data packet, the processor being further configured to analyze the inspected data packets using ASCII character string pattern matching.

13. The system of claim 10, wherein to resolve the IP addresses, the processor being further configured to:
search a local cache of the proxy device for the IP addresses associated with the one or more embedded host device names; and
upon failure to locate the associated IP addresses in the local cache of the proxy device, query by the proxy device one or more DNS servers to resolve the IP addresses associated with the one or more embedded host device names.

14. The system of claim 10, wherein to resolve the IP addresses, the processor being further configured to store the one or more identified host device names and the associated resolved IP addresses in a local cache of the proxy device.

15. The system of claim 10, wherein to inspect one or more data packets transmitted to the client device, the processor being further configured to inspect data packets transmitted to the client device on a first communication link having a first propagation latency.

16. The system of claim 15, wherein to transmit to the client device the inspected data packets without alterations, the processor being further configured to transmit the inspected data packets on a second communication link having a second propagation latency, wherein the first propagation latency is substantially lower than the second propagation latency.

17. The system of claim 16, wherein the client device includes a mobile device, wherein the first communication link includes a core IP network and the second communication link includes a radio access network (RAN), and wherein the communication system is hosted by an IP access gateway connecting the RAN and the core IP network.

18. The system of claim 16, wherein the first communication link includes a wide area network (WAN) and the second communication link includes a local area network (LAN), and wherein communication system is hosted by a router connecting the LAN and WAN.

19. A computer program product, comprising:
a computer-readable medium comprising:
a first set of codes for causing a computer to inspect one or more data packets transmitted to a client device;
a second set of codes for causing the computer to identify one or more host device names embedded in the inspected data packets;
a third set of codes for causing the computer to resolve IP addresses associated with the one or more embedded host device names;
a fourth set of codes for causing the computer to transmit to the client device the inspected data packets without alterations; and
a fifth set of codes for causing the computer to transmit to the client device, independent of the inspected data packets, the one or more host device names and the associated resolved IP addresses for use by the client device to establish connections to the host devices identified in the inspected data packet.

20. The product of claim 19, wherein the second set of codes further comprises a sixth set of codes for causing the computer to reconstruct code of the one or more intercepted data packets.

21. The product of claim 19, wherein the second set of codes further comprises a seventh set of codes for causing the computer to analyze the inspected data packets using ASCII character string pattern matching.

22. The product of claim 19, wherein the third set of codes further comprises an eight set of codes for causing the computer to:
search a local cache of the proxy device for the IP addresses associated with the one or more embedded host device names; and
upon failure to locate the associated IP addresses in the local cache of the proxy device, query by the proxy device one or more DNS servers to resolve the IP addresses associated with the one or more embedded host device names.

23. The product of claim 19, wherein the third set of codes further comprises a ninth set of codes for causing the computer to store the one or more identified host device names and the associated resolved IP addresses in a local cache of the proxy device.

24. The product of claim 19, wherein the first set of codes further includes a tenth set of codes causing the computer to inspect data packets transmitted to the client device on a first communication link having a first propagation latency.

25. The product of claim 24, wherein the fourth set of codes further includes an eleventh set of codes causing the computer to transmit the inspected data packets on a second communication link having a second propagation latency, wherein the first propagation latency is substantially lower than the second propagation latency.

26. The product of claim 25, wherein the client device includes a mobile device, wherein the first communication link includes a core IP network and the second communication link includes a radio access network (RAN), and wherein the computer is hosted by an IP access gateway connecting the RAN and the core IP network.

27. The product of claim 25, wherein the first communication link includes a wide area network (WAN) and the second communication link includes a local area network (LAN), and wherein the computer is hosted by a router connecting the LAN and WAN.

28. An apparatus, comprising:
means for inspecting one or more data packets transmitted to a client device;
means for identifying one or more host device names embedded in the inspected data packets;
means for resolving IP addresses associated with the one or more embedded host device names;
means for transmitting to the client device the inspected data packets without alterations; and
means for transmitting to the client device, independent of the inspected data packets, the one or more host device names and the associated resolved IP addresses for use by the client device to establish connections to the host devices identified in the inspected data packet.

29. The apparatus of claim 28, wherein means for identifying one or more host device names embedded in the inspected data packet comprises means for reconstructing code of the one or more intercepted data packets.

30. The apparatus of claim 28, wherein means for identifying one or more host device names embedded in the inspected data packet comprises means for analyzing the inspected data packets using ASCII character string pattern matching.

31. The apparatus of claim 28, wherein means for resolving the IP addresses further comprises:
means for searching a local cache for the IP addresses associated with the one or more embedded host device names; and
means for querying one or more DNS servers to resolve the IP addresses associated with the one or more embedded host device names upon failure to locate the associated IP addresses in the local cache.

32. The apparatus of claim 28, wherein means for resolving the IP addresses further comprises means for storing the one or more identified host device names and the associated resolved IP addresses in a local cache.

33. The apparatus of claim 28, wherein means for inspecting one or more data packets transmitted to the client device comprises means for inspecting data packets transmitted to the client device on a first communication link having a first propagation latency.

34. The apparatus of claim 33, wherein means for transmitting to the client device the inspected data packets without alterations comprises means for transmitting the inspected data packets on a second communication link having a second propagation latency, wherein the first propagation latency is substantially lower than the second propagation latency.

35. The apparatus of claim 34, wherein the client device includes a mobile device, wherein the first communication link includes a core IP network and the second communication link includes a radio access network (RAN), and wherein the apparatus is hosted by an IP access gateway connecting the RAN and the core IP network.

36. The apparatus of claim 34, wherein the first communication link includes a wide area network (WAN) and the second communication link includes a local area network (LAN), and wherein the apparatus is hosted by a router connecting the LAN and WAN.
